(19) United States
(12) Patent Application Publication
(10) Pub. No.: US 2025/0155200 A1
(43) Pub. Date: May 15, 2025

(54) Infusion heater and system for heating a liquid product using saturated steam

(71) Applicant: H. Kjærbye Invent ApS, Randers NV (DK)

(72) Inventors: Henrik Kjærbye, Randers NV (DK); Rodrigo Esteban Segura Reyes, Randers NV (DK); Mathias Dølrath Toft, Randers NV (DK)

(21) Appl. No.: 18/839,908

(22) PCT Filed: Feb. 20, 2023
(86) PCT No.: PCT/EP2023/054207

§ 371 Date: Aug. 20, 2024

(30) Foreign Application Priority Data
Feb. 21, 2022 (EP) 22157826.3

(51) Int. Cl. F28C 3/08; B05B 1/06; B05B 7/00

(52) U.S. Cl. CPC F28C 3/08; B05B 1/06; B05B 7/0075

(57) ABSTRACT

An infusion heater is for heating a liquid product. In operation, the liquid product enters an infusion chamber through an inlet nozzle and travels vertically through the infusion chamber in free fall along the infusion chamber and exits the infusion chamber through a product outlet. The infusion chamber further comprises at least one steam inlet arranged so that in operation steam enters the chamber between the product and the infusion chamber walls. The disclosed infusion heater facilitates that heat exchange between the product and the inner and outer body parts of the inlet nozzle can be better controlled as constant product contact can be established, which reduces the risk of hotspots and thereby burn-ons. In another aspect there is disclosed an air vent arranged in the lower half of the infusion chamber, which facilitates effective venting of air.

### CROSS-REFERENCE TO RELATED APPLICATIONS

This application is the U.S. National Stage of PCT/EP2023/054207 filed on Feb. 20, 2023, which claims priority to European Patent Application 22157826.3 filed on Feb. 21, 2022, the entire content of both are incorporated herein by reference in their entirety.

### BACKGROUND OF THE INVENTION

In the food and beverage industries it is customary to improve shelf life by subjecting the food or beverage product to heat treatment.

Typically, the heat treatment is a pasteurization, a heat treatment to provide extended-shelf-life (ESL) or UHT (ultra-high temperature) treatment.

Pasteurization is a process in which milk and certain packaged and non-packaged liquid foods (such as fruit juice or beverages) are treated with mild heat, usually to less than 100° C., for a period necessary to eliminate pathogens, typically 10-30 seconds or more e.g. up to 1-2 or more minutes, depending on the product and/or whether only microbial deactivation as well as heat treatment done for other reasons, denaturation or deactivation of proteins are required. The pasteurization process also extends shelf life of the food products. Pasteurization also destroys or deactivates non-pathogenic microorganisms including vegetative bacteria, but not bacterial spores. Thus, the risk of ingesting food containing pathogens is reduced, which also reduces the risk of diseases and/or spreading thereof.

ESL products are the products that have been treated in a manner to reduce the microbial count beyond normal pasteurization, followed by packaging under hygienic conditions. ESL products have a defined prolonged shelf life under refrigeration conditions. At present there is no generally accepted definition of ESL heat treatment. ESL heat treatment to provide ESL products, e.g. ESL-milk, fills the gap between pasteurization and ultra-high temperature treatment (UHT). Extended-shelf-life (ESL) heat treatment on milk is usually applied at 120-135° C. for 1-4 seconds to extend shelf life of processed liquid milk products.

UHT treatment is mostly used to sterilize liquid food by heating it above 135° C. for 2 to 5 seconds or further dependent on the kill rate desired UHT is most commonly used in milk production, but the process is also used for flavoured milks, cream, soy milk, soups, in order to kill spores, microorganisms, vira etc. UHT milk can for example be stored for a few months without cooling, which is an added convenience.

Food products which undergo such heat treatment, is typically fluid products or semi-fluid products, for example dairy products, fruit and/or vegetable-based products, juice from fruit and/or vegetables, vegetable based milk substitutes, such as milk substitutes based on soy, oat, nuts, almonds and/or mixtures thereof, drinks of any kind, e.g. soft drinks, as well as culinary products such as soups, broth, stews, gravies, desserts, e.g. puddings, and/or condiments.

Examples of dairy products are liquid dairy products such as milk, flavoured milk cream and/or yoghurt or similar fermented milk or cream based products and/or milk based liquid, whey or liquid or semi liquid food products based on whey or semi liquid desserts.

It is common to use direct heating by saturated steam in an infusion system or injection heating when heat treating such liquid or semi liquid food products.

In such systems the product is led into the infusion chamber where the atmosphere is made up of saturated steam which is maintained at a desired pressure and temperature. The product falls through the infusion chamber with limited or no contact with the inside of the infusion chamber and leaves the infusion chamber through an outlet in the bottom. As the product passes through the chamber it is heated by the saturated steam condensing into the product, thereby elevating the temperature to the desired level in accordance with a set point.

It is known that during the infusion of the product to be heated, air is liberated from the product. This creates a mixed atmosphere of gas (air) and steam in the chamber which makes the infusion chamber less efficient in its function because it decreases the partial pressure of steam in the infusion chamber and thus reduces the heat transfer to the product. In order to remove the undesired air buildup air vents have been provided in known infusions chambers. However, they have been arranged in such a way that more steam than air has been removed at the same time, reducing the effectiveness of such air venting causing issues in operation and unnecessary loss of energy in the process

Furthermore, it is important to control the flow of the product into and through the infusion chamber as atomization and spraying should be avoided in order to for example reduce the risk of residue on unwanted areas of the infusion chamber, such as the walls. Mean travel time of the product will also be affected as smaller particulates (atomizes) will risk a longer residence time in the chamber by floating around as they are less affected by gravity. In particular atomization may increase the risk of burn-on, i.e. a parts of the product that has been deposited on a surface in the infusion chamber burns on and which in the end will affect the product characteristics, such as taste, Maillard reaction etc.

Thus, nozzles and implementations that apply atomization and misting is not suitable for use in infusion heaters and systems as discussed herein.

Furthermore, there are different types of heating a product using steam. One principle is a so-called steam injection where steam is injected under high pressure in order to converge with a product. Although such injection heating potentially heats and thus treats the product very fast it is difficult to control undesired atomization and spraying, typically due to cavitation, and thus an increased risk of burn-on exist along with a high risk of superheated steam.

Also, since injection heating works by converging the steam and product at high pressure the steam and product inlet is typically very close to each other in order to obtain the desired effect, where the steam inlet in an absorption or infusion heater is further away from the product, typically in order to reduce the risk of overheating by superheated steam.

Accordingly, the current disclosure relates to absorption or infusion heating where the pressure in the chamber during heat treatment is lower and the steam is absorbed into a laminar flow of the product instead of injected by stirring/converging the product. In such cases the pressure in the chamber is controlled such that the product is just around the boiling point. For example, where a product that is to be treated from 80° C. to 143° C. in the infusion heater this may be done by keeping the pressure at 3 bar which also may be obtained by controlling the steam inlet.

Thus, there is a need to accommodate, minimize or remove the above issues as will be discussed further herein. In general it is a desire to provide a laminar flow of the product, i.e. with little or no turbulence and thus reduce the risk of for example atomizing. Also with a laminar flow it is easier to control the speed and flow direction of the product, e.g. creating an even flow in the system.

### SUMMARY OF THE INVENTION

In first aspect disclosed herein an infusion heater for heating a liquid product is provided, wherein the infusion heater comprises an infusion tank defining an infusion chamber comprising an inlet nozzle arranged in an inlet area and a product outlet arranged in an outlet area, the inlet area and the outlet area are arranged opposite each other so that in operation the liquid product enters the infusion chamber through the inlet nozzle travels vertically through the infusion chamber in free fall along a longitudinal axis L-L of the infusion chamber and exits the infusion chamber through the product outlet, wherein the infusion chamber further comprises at least one steam inlet arranged so that in operation steam enters the chamber between the product and the infusion chamber walls,

wherein the inlet nozzle comprises a cup-shaped outer body, comprising a base plate and an annular wall extending from the base plate to an open end defining a cavity facing the outlet area, and wherein an inner body is at least partly received in the cavity and that the inner body is dimensioned so that surfaces of the inner body facing the surfaces of the outer body are offset so that a cavity channel is defined between the inner body and the outer body, wherein at least one inlet channel extend through the base plate in communication with the cavity channel so that in operation product is injected into the inlet nozzle through the inlet channel and further through the cavity channel and out into the infusion chamber via an at least one outlet opening at the end of the cavity channel downstream from the inlet channel.

This allows for an infusion heater where the heat exchange between the product and the inner and outer body parts easier can be controlled as constant product contact can be established, which can reduce the risk of hotspots and thereby burn-ons. Moreover, by further controlling the speed of the product throughout the inlet nozzle as described, such burn-ons can be even further reduced.

The inlet nozzle also facilitates cleaning, e.g. cleaning in place (CIP), where cleaning is performed without disassembling the infusion tank in place, as opposed to cleaning out of place (COP) where the infusion tank has to be assembled, typically off-site, and cleaned. In particular the CIP is facilitated as the velocity is calibrated throughout the nozzle both for having a similar gradient of heat transfer as well as suitable product and CIP velocities.

Further, the inner surface of the annular wall can be designed to taper inwardly toward the open end. This provide a guiding surface for the product so that it is directed to converge towards the centre of the infusion chamber, e.g. around the longitudinal axis L□ L. and near to the exit of the chamber.

Also, the inlet nozzle of the infusion heater may be provided with an outer edge lip of the annular wall of the outer body extends beyond an opposing inner edge lip of the inner body along the longitudinal axis L□ L toward the outlet area. This serves to further reduce atomisation of the product towards the wall of the chamber, and controls it so atomization primarily will wander towards the centre of the chamber, e.g. towards the longitudinal axis L□ L.

Thus, as will be understood herein the nozzle design disclosed allows for a relative higher product injection speed into the infusion chamber. The speed is however depending on the product and its properties. In principle it is desired to have a high dispersion of the product as this will provide much faster absorption of heat from the steam, thus increasing the speed of the infusion heating process, however product characteristics will decide the velocities to be chosen.

However, increasing the injection speed also increases the amount of dispersion in atomised form, i.e. when the dispersion of the product becomes too fine. In this state the product becomes difficult to control and there is an increased risk that the atomized particles flows into unwanted areas and deposits on undesired surfaces, or even worse create burn-ons where the product burns onto surfaces risking ruining the product batch and requires extensive cleaning of the infusion heater.

The design of nozzle, for example the tapering of the inner surface and the outer edge lip of the annular wall as disclosed directs atomised product particles towards the centre of the chamber, e.g. the longitudinal axis, where it typically will be reabsorbed by the dispersed converging product flow consisting of larger particles.

In one aspect disclosed herein an inlet nozzle for use in an infusion heater is thus disclosed, wherein the inlet nozzle comprises a cup-shaped outer body, comprising a base plate and an annular wall extending from the base plate to an open end defining a cavity, and wherein an inner body is at least partly received in the cavity and that the inner body is dimensioned so that surfaces of the inner body facing the surfaces of the outer body are offset so that a cavity channel is defined between the inner body and the outer body, wherein at least one inlet channel extend through the base plate in communication with the cavity channel so that in operation product is injected into the inlet nozzle through the inlet channel and further through the cavity channel and out into the infusion chamber via an at least one outlet opening at the end of the cavity channel downstream from the inlet channel.

As discussed herein the design of such inlet nozzle facilitates the control and flow of the product in the infusion chamber of an infusion heater.

It has shown that in some embodiments the product flowing out from the nozzle creates a curtain that encloses an air volume wherein a low pressure is created. The low pressure has been seen to interrupt the flow of product and even suck product into the enclosed air volume. This can for example be the case in embodiments where the at least one outlet opening is annular.

In order to mitigate or avoid such a situation at least one interruption member can be arranged in the cavity channel of the inlet nozzle so that in operation the at least one interruption member interrupts the flow of the product in the cavity channel. This provide a gap in the product flow, e.g. curtain, which provides a pressure equalising bridge to the enclosed air volume.

The at least one interruption member can for example be a protrusion extending from the surface of the inner body facing the outer body. The at least one interruption member can for example be arranged at the at least one outlet opening.

In a further embodiment the inlet nozzle is designed to further reduce turbulence when the product flows through and thus results in laminar flow passing into the infusion tank.

For example the inlet nozzle may in one embodiment comprise a single inlet channel allowing product to enter the cavity channel via only one passage. This reduces turbulence in the product flowing through the cavity channel since multiple inlet channels would result in product flow coming in at different places which creates different oriented flow and thus increases the risk of undesired turbulence which may result in an uneven non-laminar product flow.

In one embodiment the inlet nozzle comprises a disc shaped base plate arranged with a centre along a longitudinal axis L□□ L□ of the inlet nozzle and the single inlet channel is arranged co-axially along the longitudinal axis extending through the disc shaped base plate. The inlet channel is preferably cylindrically shaped defining a single channel extending along the axis L L allowing for flow of product along the longitudinal axis during operation.

The annular wall extends from the periphery of the disc shaped base plate, such that it forms a circular shaped annular wall, which together with the disc shaped base plate form the cup-shaped outer body arranged co-axially with the longitudinal axis L□□ L□. The cup-shaped outer body defines a cavity, which extends along the longitudinal axis L□□ L□ in communication with the inlet channel. The cavity preferably has a diameter which is larger than the inlet channel.

Furthermore, in one embodiment, the inner body is formed as a cylindrical element which has a diameter which preferably smaller than the diameter of the cavity, but larger than the diameter of the inlet channel, such that when it is arranged coaxially with the longitudinal axis L□□ L□ within the cavity of the outer body the cavity channel is defined between the outer body and the inner body.

The surface of the inner body facing the inlet channel is formed as a uniform and continuously extending surface. This allows the product from the inlet channel to be evenly distributed outwards towards annular wall of the outer body from where it is further guided along the longitudinal axis L□□ L□ in the cavity channel defined between the annular wall of the outer body and the inner body and out of the nozzle through the outlet opening.

As described the surface of the inner body facing the inlet channel is in one embodiment uniform and extends continuously outwards from the longitudinal axis L□□ L□. Such surface may in a simple form be a flat surface, e.g. disc shaped surface extending perpendicular to the longitudinal axis L□□ L□. In another embodiment the surface may be conical, e.g. it has an apex arranged on the longitudinal axis L□□ L□ from which the surface slants outwards. The slant may be described as a surface which extends at an angle from the longitudinal axis L□□ L□ which is not perpendicular nor parallel thereto, but a range between 0° and 90□, preferably between 45□ and 90□.

The surface of the base plate facing the inner body may be formed similar to the surface of the inner body facing the inlet channel, i.e. they may both extend perpendicular to the longitudinal axis L□□ L□, or they may slant with the same angle.

Furthermore, in a different embodiment the surface may slant at different angles which thereby forms a tapering first part of the cavity channel extending from the inlet channel towards the annular wall, i.e. transverse to the longitudinal axis. In another embodiment the angles may be different such that the first part of the cavity channel opens up, e.g. opposite tapering, towards the annular wall. Such narrowing or opening of the cavity channel may impose different flow characteristics and affect the flow of the product out through the outlet opening and into the infusion chamber and may thus be used to obtain the desired flow.

As discussed, the cavity channel is defined by the cup-shaped outer body and the inner body received in the cavity of the outer body, where a first part of the cavity channel extending transverse to the longitudinal axis L□□ L□ is defined by the surface of the base plate facing the inner body and the surface of the inner body facing the inlet channel, and a second part of the cavity channel extending along the longitudinal axis L□□ L□ is defined by the surface of the annular wall facing the inner body and the surface of the inner body facing the annular wall.

In one embodiment the first part of the cavity channel extending transverse to the longitudinal axis L□□ L□ comprises that the surface of the base plate facing the inner body and the surface of the inner body facing the inlet channel forms an angle to the longitudinal axis L□□ L□ of between 45□ and 90□ degrees. They may form the same or different angles within said interval.

In one embodiment the second part of the cavity channel extending along the longitudinal axis L□□ L□ comprises that the surface of the annular wall facing the inner body and the surface of the inner body facing the annular wall forms and angle to the longitudinal axis L□□ L□ of between 0 and 45 degrees. They may form the same or different angles within said interval.

In one embodiment, when seen in cross sections along the longitudinal axis L□□ L□ the cavity channel is U shaped. Where the base of the □U□ is the first part of the cavity channel extending from the inlet channel toward the annular wall, and the legs of the □U□ are the second part of the cavity channel extending from the first part of the cavity channel along the longitudinal axis L□□ L□ to the outlet opening.

Thus, it will be understood that the product entering the cavity channel from the inlet channel will spread out in a circular pattern in the first part of the cavity channel and in the second part of the cavity channel the product will be guided out in the infusion chamber via the outlet opening in a circular curtain.

In some embodiment the inner body is a solid element such than no liquid or fluid communication is established from the outside of the outer body through the inner body. For example as discussed for some embodiments, the surfaces of the inner body facing the outer body and thus defining part of the cavity channel are formed as uniform and continuously extending surfaces.

As described above the inlet nozzle has been described in relation to the longitudinal axis L□□ L□ of the inlet nozzle. In many embodiments when the inlet nozzle is arranged in the infusion heater the longitudinal axis L□□ L□ of the inlet nozzle will be co-axially with the longitudinal axis L□ L of the infusion heater.

However, in some embodiments it may be desired to arrange the inlet nozzle in the infusion heater such that the longitudinal axis L□□ L□ is offset, but still parallel, to the longitudinal axis L□ L. In other words the inlet nozzle is not placed in the centre of the infusion heater.

In yet another aspect there is disclosed an infusion heater for heating a liquid product, wherein the infusion heater comprises an infusion tank defining an infusion chamber comprising an inlet nozzle arranged in an inlet area and a product outlet arranged in an outlet area, the inlet area and the outlet area are arranged opposite each other so that in operation the liquid product enters the infusion chamber through the inlet nozzle travels vertically through the infusion chamber in free fall along a longitudinal axis L-L of the infusion chamber and exits the infusion chamber through the product outlet, wherein the infusion chamber further comprises at least one steam inlet arranged so that in operation steam enters the chamber between the product and the infusion chamber walls. The infusion heater further comprises at least one air vent which is arranged in the lower half of the infusion chamber, e.g. closer to the product outlet than the inlet nozzle.

As discussed previously it is known that during the infusion of the product to be heated, air is liberated from the product, which reduces the temperature in the chamber. The current disclosure recognizes that the air will fall toward the bottom of the infusion chamber, thus by providing an air vent closer to the product outlet than the inlet nozzle it is possible to effectively evacuated undesired air and ensure proper temperature in the infusion chamber in a simple and effective manner.

Furthermore, it has also shown that air accumulation in the outlet area reduces the effectiveness of foam removal by cooling as will be discussed further.

The effective removal of the foam by using a cooling jacket will be aided by a more effective removal of the air, which provides a shorter mean residence time in the system.

Furthermore, the accumulation of a higher fraction of air in the steam atmosphere often results in poor performance of the infusion system itself, meaning that the product may not have reached full temperature when reaching the outlet.

This results in the final heating only happening in the exit system of the chamber, doing great harm to the product, such as cavitation and denaturation.

Further air vents may be provided, e.g. in the upper half of the infusion chamber.

In yet a further aspect there is disclosed a steam distribution plate comprising an annular disc configured/designed to be arranged in an infusion chamber, such as an infusion chamber in an infusion heater as described herein. The steam distribution plate further comprises multiple through going holes arranged in a ring-shaped pattern encircling the centre of the annular disc, for example the longitudinal axis L□ L of the infusion chamber.

This allows for a low pressure inlet of the saturated steam into the infusion chamber and with minimal turbulence, which in turn minimises the risk that atomized product particles are sent wandering off and are disposed on unwanted surfaces.

In yet another aspect there is disclosed there is disclosed an infusion heater for heating a liquid product, wherein the infusion heater comprises an infusion tank defining an infusion chamber comprising an inlet nozzle arranged in an inlet area and a product outlet arranged in an outlet area, the inlet area and the outlet area are arranged opposite each other so that in operation the liquid product enters the infusion chamber through the inlet nozzle travels vertically through the infusion chamber in free fall along a longitudinal axis L-L of the infusion chamber and exits the infusion chamber through the product outlet, wherein the infusion chamber further comprises at least one steam inlet arranged so that in operation steam enters the chamber between the product and the infusion chamber walls. In the current aspect the steam inlet extends along an steam axis S□ S which form an oblique angle α to the longitudinal axis L□ L.

In one embodiment the angle α is in the range of 20□□ 70□, preferably 45□.

It has shown that although stream distribution plates as discussed herein facilitates steam distribution into the infusion chamber they may also create undesired turbulence and circulation of the steam. In an alternative aspect it has thus been realised that the steam may be directed directly onto the product, i.e. the longitudinal axis L□ L at an oblique angle. Thus no object interferes with steam which may cause undesired turbulence or flow of the steam. As discussed, reducing or avoiding turbulence in the chamber reduces the risk of product particles scattering and the risk of burn-on. This is particularly effective when there is a line of sight from the at least one steam inlet to the longitudinal axis, e.g. the product in free fall during operation, along the steam axis S□S.

In one embodiment line of sight comprises that the steam may freely pass from the at least one steam inlet to the longitudinal axis, i.e. the product in free flow during operation without obstruction. For example, to test for line of sight in one embodiment it may be considered that the at least one steam inlet opening may be extruded along the steam axis S□ S to the longitudinal axis L□ L without encountering any obstacle such as an object in its path.

In one embodiment the at least one steam inlet is provided in the infusion heater between the inlet nozzle and the product outlet along the longitudinal axis L□ L, such that in operation the at least one steam inlet is arranged below the inlet nozzle.

### BRIEF DESCRIPTION OF THE DRAWINGS

Aspects of the disclosure may be best understood from the following detailed description taken in conjunction with the accompanying figures. The figures are schematic and simplified for clarity, and they just show details to improve the understanding of the claims, while other details are left out. Same reference numerals may be used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 illustrates an embodiment of an infusion heater disclosed herein;

FIGS. 2a and 2b illustrates an embodiment of an inlet nozzle disclosed herein, the inlet nozzle may be used in the infusion heater of FIG. 1, however, it may also be used in other embodiments of infusion heaters;

FIG. 3 illustrates an embodiment of a steam distribution plate disclosed herein;

FIGS. 4a, 4b and 4c shows different embodiments of the outlet opening of the inlet nozzle;

FIG. 5 shows another embodiment of an infusion heater disclosed herein; and

FIG. 6a□ 6h shows an embodiment of an inlet nozzle assembly comprising an inlet nozzle as disclosed herein.

### DETAILED DESCRIPTION OF THE PREFERRED EMBODIMENT

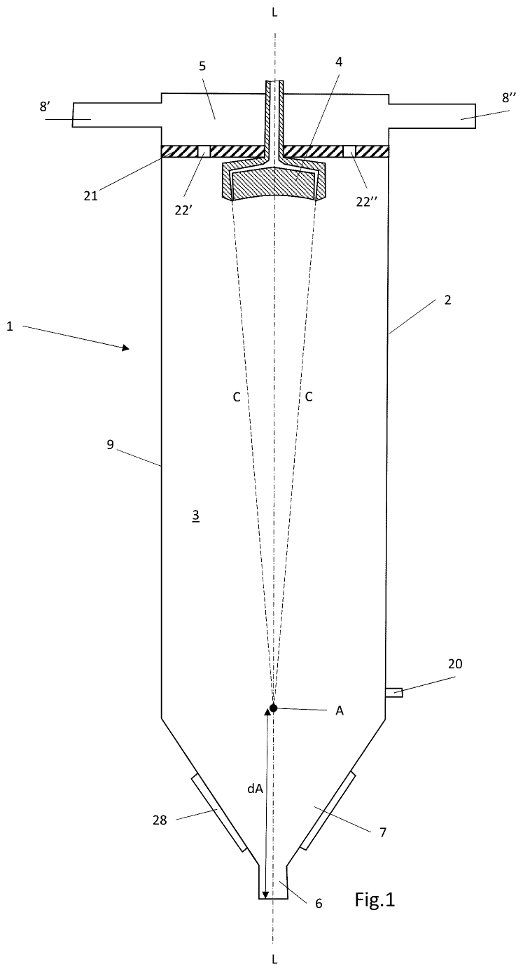

FIG. 1 shows an embodiment of an infusion heater 1 for heating a liquid product.

The infusion heater is made up of an infusion tank 2 which extends along a longitudinal axis L□ L between an inlet area 5 and an outlet area 7. The walls 9 of the infusion tank defines an infusion chamber 3.

An inlet nozzle 4 is disposed in the inlet area 5 opposite a product outlet 6 in the outlet area 7. During operation a product (not shown) is injected into the injection chamber 3 via the inlet nozzle 4 and travels vertically across the infusion chamber 3 in free fall along the longitudinal axis L□ L and exits the infusion chamber through the product outlet 6.

The infusion chamber 3 shown in FIG. 1 has two steam inlets 8□,8□□. During operation saturated steam (not shown) is injected into the inlet area 5 through the two steam inlets.

The length of the chamber, and other dimensions if relevant, are typically designed based on the exit speed of the product. In one embodiment the product should spend around 0.25 seconds until exiting from the chamber through the product outlet 6 where it has been heated to the desired temperature

In order to evenly disperse the steam in the infusion chamber a steam distribution plate 21 is arranged in the inlet area 5 between the at least one steam inlet 8□,8□□ and the inlet nozzle 4 or the outlet opening 25 of the inlet nozzle, relative to the longitudinal axis L-L, wherein multiple thoroughgoing holes 22□,22□□ are arranged in the steam distribution plate.

This reduces or even prevents turbulence to spread when the steam enters the infusion chamber from above the inlet nozzle. Further, it allows for a low pressure saturated steam stream provided by the steam inlets 8□,8□□ to be dispersed evenly and with a controlled velocity along with some measure of cooling of any superheating of the steam.

The through going holes 22 are arranged in a ring-shaped pattern, see FIG. 3, encircling the longitudinal axis L□ L, which discloses one embodiment of how the steam may enter the infusion chamber between the product and the infusion chamber walls 9. Also, a central through going hole 23 is provided and dimensioned so that the inlet nozzle may extend through the steam distribution plate.

The design of the chamber and steam distribution are preferably designed and operated so that the steam velocities are 5 m/s or less. This reduces the risk of turbulence in the infusion chamber and consequently a better control of the products travel through the infusion chamber is achieved.

In the embodiment disclosed in FIG. 1, an air vent 20 is arranged in the chamber wall 9 in the lower half of the infusion chamber, e.g. closer to the product outlet than the inlet nozzle. This allows for air to be more effectively evacuated and also avoids unwanted evacuation of the saturated steam. This in in turn results in a more energy efficient infusion process.

In one embodiment, not shown, an upper air vent may be provided in the upper half of the chamber in case it is necessary to evacuate steam.

The bottom of the infusion chamber may be equipped with a concentric cooler 28 covering the lower part, e.g. around the outlet area, of the infusion chamber. The cooler can be activated to reduce foaming of the product when it leaves the infusion chamber, or just to help forming condensate to rinse the outlet.

However, as discussed air build up around the cooler reduces the effectiveness of the cooler and foaming of the product becomes hard to control. Thus it can be understood that by placing an air vent in the lower half of the infusions chamber it is possible to improve the effectiveness of the infusion process, since removal of the air in the steam is improved and foaming can be better mitigated.

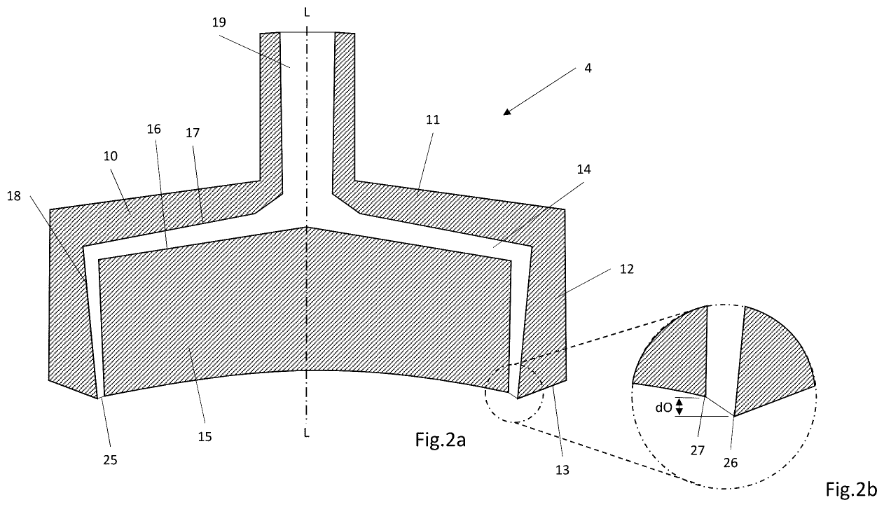

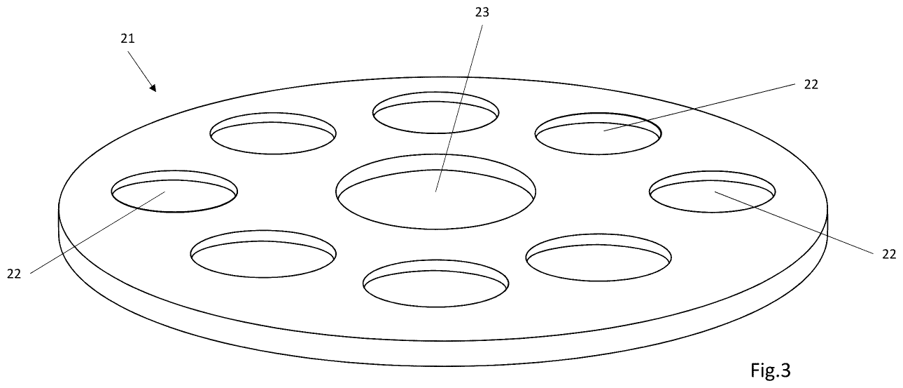

The inlet nozzle 4 is shown in further detail in FIGS. 2a and 2b.

The inlet nozzle 4 is formed of a cup-shaped outer body 10 and an inner body 15 received in the cup. I.e. the outer body is shape by a base plate 11 with an annular wall 12 extending therefrom to an open end 13.

The base plate 11 and the annular wall defines a cavity 14, and as can also be seen in FIG. 1 the cavity faces the outlet area 7 when the inlet nozzle is arranged in the infusion heater.

The inner body 15 is received in the cavity and the dimensions of the inner body is determined so that surfaces 16 of the inner body facing the outer body are offset from the surfaces 17 of the outer body facing the inner body, i.e. the surfaces of the cavity, so that a cavity channel 18 is defined between the inner body 15 and the outer body 10.

Furthermore, an inlet channel 19 extend through the base plate 11 in communication with the cavity channel 18 so that in operation product is injected into the inlet nozzle 4 through the inlet channel 19 and further through the cavity channel 18 and out into the infusion chamber via an outlet opening 25 at the end of the cavity channel 18 downstream from the inlet channel 19.

The inner surface 22 of the annular wall 12, i.e. the surface the annular wall defining the cavity 14, is designed to taper inwardly as it extends from the base plate towards the open end of the annular wall. As discussed previously this provides a design wherein product that exits the inlet nozzle through the outlet opening 25 is guided towards the centre of the infusion chamber, where the centre is illustrated by the longitudinal axis L□ L.

When designing the tapering inner surface 22 the angle of the taper is relevant to consider in order to optimize the product flow.

Accordingly, in one embodiment and as disclosed in FIG. 1, the inner surface 22 can be considered to describe a cone surface, shown as broken line C, around the longitudinal axis L□ L.

By designing the tapering of the inner surface so that the cone surface lines C converges on the longitudinal axis L□ L at an apex A which is placed 20%, of the of the extent of the infusion chamber along longitudinal axis L-L), from the product outlet 6 inside the infusion chamber along the longitudinal axis L□ L passage of the product through the infusion chamber provides many of the benefits described herein.

It has shown that stable performance can be achieved in some embodiments, when the tapering of the inner surface 22 is designed so that the apex A vary with a distance dA of between 0%□ 20% of the extent of the infusion chamber along longitudinal axis L□ L, cm from the product outlet depending on the embodiment.

The product can alternatively or in addition also be guided by an outer edge lip 26 of the annular wall 12 of the outer body, which extends beyond an opposing inner edge lip 27 of the inner body along the longitudinal axis L□ L toward the outlet area. This embodiment is also illustrated in an enlarged section in FIG. 2b.

The outer edge lip 26 may extend with a distance d0 of e.g. 0.5□ 5 mm, preferably 1□ 3 mm beyond the surface of the inner body.

Again, by guiding the distribution of product from outlet opening with atomization mainly on the inside it is possible to capture atomization by using both the curtain effect of the mainly annular distribution of product and steam the flow.

As discussed previously, the inlet nozzle design, reduces the risk of hotspots and burn-ons. In particular since the outer and inner body describe a well-defined cavity channel 18 it is possible to control the temperature in the inlet nozzle. For example, in one embodiment, the outer body and the inner body are designed so that the temperature difference ΔT between the facing surfaces of the inlet nozzle and the product is less than 5 degrees Celsius during operation. For example, based on the low thermal conductivity and the thickness of the walls the design of the flow can be determined so that the ΔT towards the product does not exceed a determined temperature, e.g. 5 degrees Celcius.

In order to further facilitate the control of the product flow through the inlet nozzle and ensure correct temperature therein the offset may decrease from the inlet channel 19 towards the outlet opening 25. This provides a tapering channel that narrows as the product flows through, increases the velocity and dispersion when the product enters the infusion chamber.

The outer and inner body may be coupled in different ways (not show) by providing coupling arrangements on the respective bodies to couple them together.

For example in one embodiment, the coupling arrangement (not shown) is a bolt extending through a bolt channel in the inner body along longitudinal axis L□ L. The bolt engages with a threaded mating part suspended in the inlet channel by multiple attachment bridges allowing the product to flow between the attachment bridges during operation.

In order to maintain the offset, and thereby the cavity channel design multiple spacers may be formed as protrusions on the surface of the inner body facing the base plate or vice versa.

Moreover in one embodiment, the majority of the parts are symmetrically shaped around the longitudinal axis L□ L. Accordingly, it may be understood that the infusion tank is cylindrical having an annular tank wall. The inlet nozzle may also be annular in shape with one or more annular ring shaped outlet openings, where the product can exit in a curtain shape when the infusion chamber is operating. Although the product initial exits as a curtain it will often disperse as it passes through the infusion chamber towards the product outlet.

Air evacuation, e.g. through the air vent 20 can be done and adjusted in accordance with need from different levels based on the difference in specific weight of the air vs. the steam at different pressures. In short, the evacuation of the air and steam mixture can be done in accordance with needs at higher or lower levels of evacuation from the chamber.

The advantage of doing at a lower level is that the efficiency of removal increases the further down in the chamber it can be done, thereby it is possible to save on the steam (energy) lost during air evacuation.

Further, an additional air vents can be arranged, for example in the upper half if additional venting is needed in that area as well.

The benefit of arranging the air vent 20 in the lower half of the infusion chamber will be discussed in the following.

The heating temperature achieved of a product in an infusion chamber is a product of the saturated steam pressure and the derived temperature thereof.

The final temperature as derived from a Mollier diagram is however influenced by the partial gas pressure, so evacuation of air is a relevant as incoming product brought closer to the boiling point releases most of the air it contains.

This results in that the steam in the chamber becomes □contaminated□ with incondensable gases, and therefore the saturation point and the pressure, as per Molliere is not a fully valid expression for the expected final temperature. However, the incondensable gases are typically heavier than steam and thus falls toward the bottom of infusion chamber, from which they may be evacuated as discussed herein.

Any deviation by the obtained temperature can be interpreted to either gas, super heating, poor distribution of product, or build-up of product in the infusion chamber or any combination of these.

Superheating may also influence the balance as the propensity of the superheated steam to condense is very low and thus not as effective in heating the product.

The result is however that the product is burned by the superheated steam which causes proteins to aggregate in larger micelles, a common trait seen in product heated in injection heaters, which results in sediments in the final pack as well as a chalky mouthfeel.

Although the Mollier depiction of the relationship between pressure and temperature is not fully reliable, as said above, it should be used as a guidance as any difference between measured pressures vs temperatures of steam as well as product from the Mollier principles indicates issues around superheating or gas accumulation in the system.

As examples of temperature relations the following could be used.
0.4 bar absolute 0% gas 75.85° C.
0.4 bar absolute 2% gas 75.37° C.
0.4 bar absolute 4% gas 74.89° C.

It is evident that accumulation of air makes the temperature move away from the equilibrium as described by Mollier, and as part of the released gasses released and accumulated is oxygen it is potentially detrimental the products, in particular unsaturated fatty acids and Maillard prone compounds like sugar and proteins.

Super heating which is most often caused by the expansion of the steam at the regulation valve and insufficient cooling of the steam on the way to the infusion chamber. The cooling of the steam can be achieved by either extending the steam line, uninsulated to the infusion chamber or by injecting condensate into the steam line. When handling products that are heat sensitive, the removal of superheating of the vapor is of utmost importance.

Combinations at higher temperatures are far more prone to produce Maillard compounds and also very sensitive to both super heating and accumulation of gases.
4.0 bar absolute 0% gas 143.61° C.
4.0 bar absolute 2% gas 142.88° C.
4.0 bar absolute 4% gas 142.14° C.

As can be seen the trends are the same and comments would reflect the comments as laid out above.

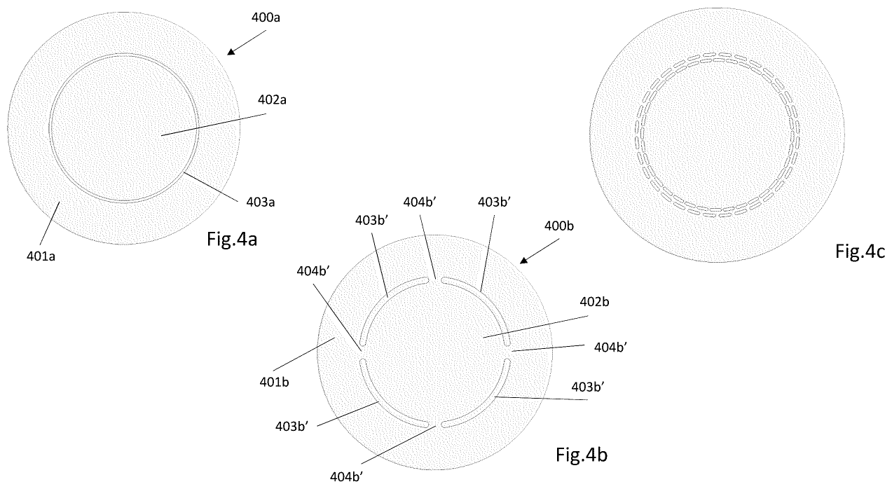

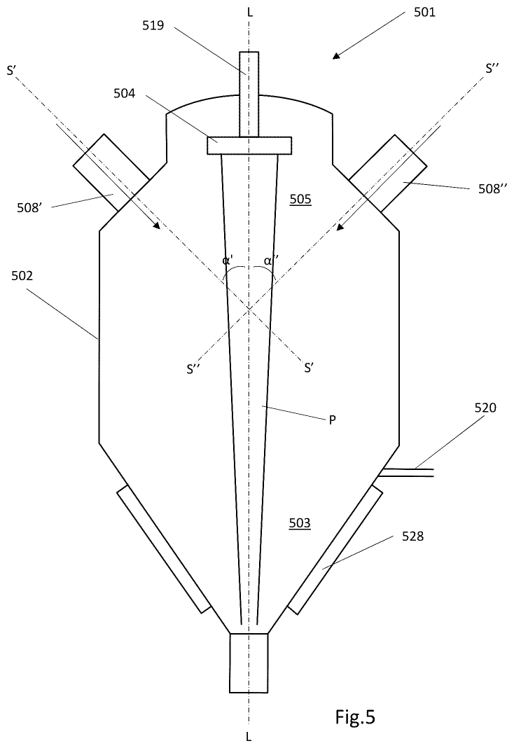

FIG. 4a shows an inlet nozzle 400a seen from below, e.g. where an annular outlet opening 403a can be seen defined between the annular wall 401a of the outer body and the inner body 402a. The annular outlet opening 403a is continuous which in some cases may result in a circular curtain of product which encloses an air volume. As discussed, this may result in a low pressure volume which may result in undesired flow properties of the product.

In order to avoid that such an enclosed air volume is created the annular outlet opening may be interrupted, e.g. a broken annular outlet opening may be provided.

For example, as shown in FIG. 4b one embodiment of an inlet nozzle 400b the annular wall 401b and the inner body 402b defines an annular outlet opening which is formed of four segments 403b□. The segments are separated by four interruption members 404b□ that extends between the annular wall and the inner body of the inlet nozzle. Thus, a design is provided where the product exiting the outlet opening is interrupted at the interruption members 404b□ and thus allows the ambient pressure to communicate with the enclosed air volume which thereby removes a low pressure build up that may disturb the flow of the product, e.g. through an infusion heater.

An even further embodiment of the inlet nozzle is shown in FIG. 4c where the two annular opening are provide and each annular openings are interrupted by multiple interruption members which ensures that a low pressure build up in the enclosed air volume is prevented.

A second embodiment of an infusion heater 501 is shown in FIG. 5.

The infusion heater may be fitted with an inlet nozzle 504 as disclosed previously, e.g. inlet nozzles 4, 400a and 400b. Also the infusion heater has an air vent 520 in the lower half of the infusion chamber 503 and a concentric cooler 528 similar to the embodiment described in FIG. 1 above.

The main difference is that the steam distribution plate is not implemented. In the current embodiment a first and a second steam inlet 508□ and 508□□ are arranged in the inlet area 505 along first steam axis S□□ S□ for the first steam inlet 508□ and along second steam axis S□□□ S□□ for the second steam inlet 508□□. Each steam axis is arranged at a 45□ angle to the longitudinal axis L□ L of the infusion tank 502 defining the infusion chamber 503.

This allows steam to be directed directly from the steam inlet channels towards product P travelling through the infusion chamber as indicated by the arrows along the respective steam axes.

In the current embodiment the steam travels with a speed of about 5 m/s, through each steam let having a diameter of 150 mm, towards the product and the product travels at 10,000 L/hr through an inlet channel 519 of the nozzle with a diameter of 40 mm. This allows the steam to be directed directly onto the product without affecting the products travel through the chamber, while providing a high heat exchange. These parameters can be changed to accommodate specific sizes and dimensions of product capacity, for example, the speed of the steam should generally not be too high as this may affect the product curtain and risk atomization or spraying of the product and it has shown that about 5 m/s or below is suitable.

Also, the angle at which steam is directed toward the product will affect the heat exchange but also risk interfering with the product flow. In the current embodiment the first and second steam inlet form identical angles α□ and α□□ at 45□.

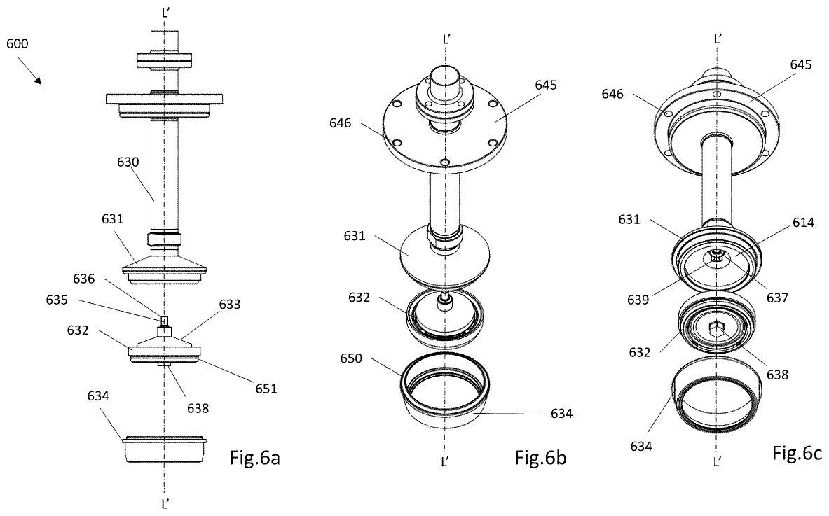

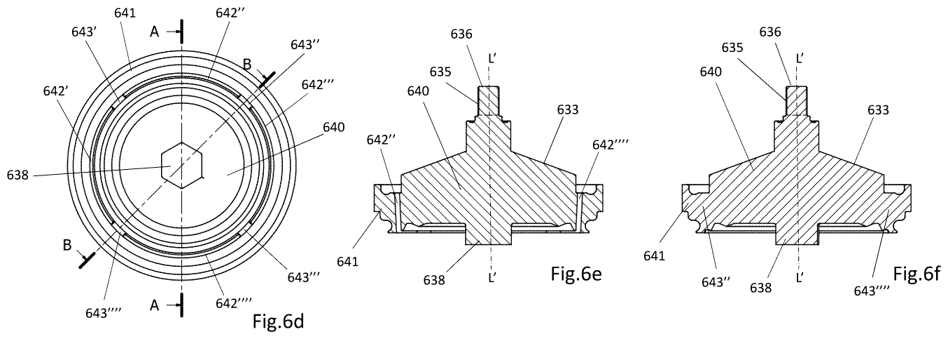

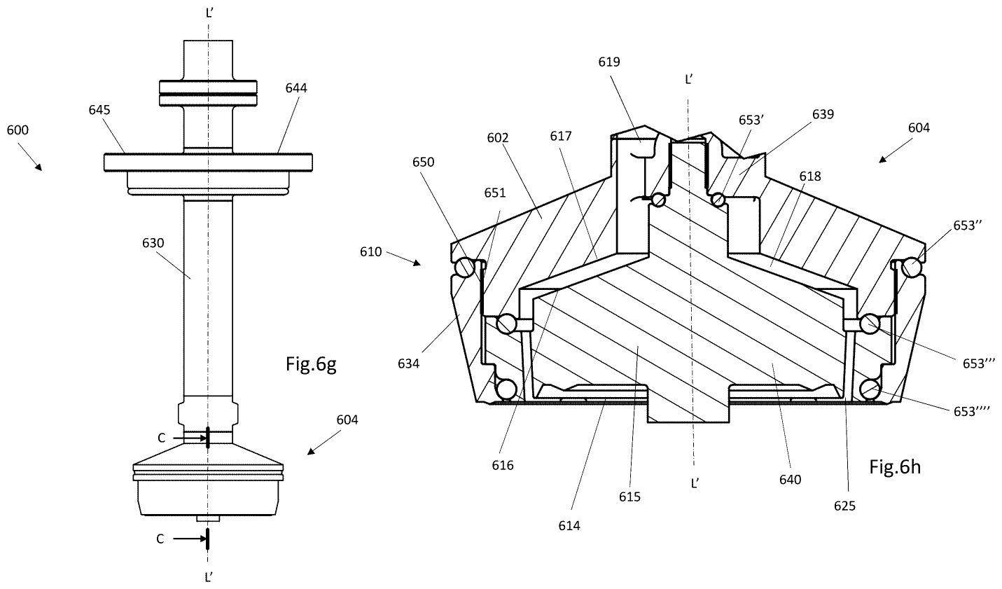

FIGS. 6a□ 6g shows an embodiment of an inlet nozzle assembly 600 which may be used in a infusion heater as described herein.

In FIGS. 6a□ 6c shows the inlet nozzle assembly in an exploded view along the longitudinal axis L□□ L□. An inlet channel 619 is defined by an inlet pipe 630 extending longitudinal along the longitudinal axis. The inlet pipe 630 is attached to a collar element 631 which extends outwards from the inlet pipe, transverse to the longitudinal axis, and defines part of a cavity 614.

A distribution element 632 is provided and designed to be received in the part of the cavity 614 defined by the collar element 631, and serves to distribute product coming from the inlet channel 619 outwards transverse to the longitudinal direction along a transverse distribution surface 633 of the distribution element.

An annular flange element 634 is arranged and encloses the distribution element 632.

The distribution element 632 is secured to the collar element 631 via a threaded coupling where outer threads 635 on a central stub 636 extending longitudinally from the distribution surface 633 engages with inner threads 637 provided within the inlet channel 619. A hex-nut head 638 is provide on the distribution element opposite the central stub which may engage with a tool to facilitate screwing the distribution element in place.

The inner threads 637 are suspended centrally within the inlet channel via three arms (one shown in FIG. 6c as arm 639) which allows the product to pass between the arms.

The distribution element 632 is shown in further detail in FIGS. 6d, 6e and 6f, where the distribution element is shown from below in FIG. 6d and in section A□ A in FIG. 6e and section B□ B in FIG. 6f.

The distribution element is divided into a central section 640 which is encircled by an outer section 641. The central section 640 and the outer section 641 are separated by annularly arranged openings 642□, 642□□, 642□□□ and 642□□□□ but connected via interruption members 643□, 643□□, 643□□□ and 643□□□□.

FIG. 6e shows the distribution element 632 in section along section A□ A in FIG. 6d, where it can be seen how the annular openings 642□□, 642□□□□ extends longitudinal through the distribution element 603 along the longitudinal axis L□□ L□.

In another section, along B□ B in FIG. 6d, it can be seen in FIG. 6f how the interruption members 643□□, 643□□□□ connects the central section 640 to the outer section 641.

In FIG. 6g the inlet nozzle assembly 600 is shown as assembled from the side. The assembly comprises the inlet nozzle 604 for dispensing the product into an infusion chamber and an attachment construction 644 which is used to attach the inlet nozzle assembly 600 to an infusion tank (not shown) of an infusion heater (also not shown), for example as described herein.

The attachment construction 644 comprises an annular flange 645 comprising through going holes 646 (seen in FIGS. 6b and 6c) through which bolts (not shown) may be used to attach the assembly to the infusion tank.

The inlet nozzle 604 is in FIG. 6h shown in section along C□ C in FIG. 6g.

As shown inner threads 650 on the annular flange element 634 engages with outer threads 651 on the collar element 631.

As the annular flange element 623 and the collar element 631 are screwed together an inner recess 652 is defined which retains the outers section 641 of the distribution element 632.

Four O-rings 653□, 653□□, 653□□□ and 653□□□□ are arranged in the inlet nozzle where the different parts of the inlet nozzle connects to ensure a fluid tight seal.

In particular it can be seen that the wherein the inlet nozzle 604 comprises a cup-shaped outer body 610 defined by the collar element 631, the annular flange element 634 and the outer section 641 of the distribution element 632.

The central section 640 of the distribution element 632 forms an inner body 615 which is received within the cavity 614 defined by the outer body 610.

The inner body is dimensioned so that surfaces 616 of the inner body facing the surfaces 617 of the outer body are offset so that a cavity channel 618 is defined between the inner body and the outer body.

The inlet channel 619 thus extend through the outer body 610 in communication with the cavity channel 618 so that in operation product is injected into the inlet nozzle 604 through the inlet channel 619 and further through the cavity channel 618 and out into the infusion chamber via an at least one outlet opening 625 at the end of the cavity channel 618 downstream from the inlet channel 619.

As previously discussed the inlet nozzle assembly 600 may be arranged in an infusion heater such that the longitudinal axis L□ L of the infusion heater extends co-axially with the longitudinal axis L□□ L□ of the inlet nozzle assembly 600.

Also, as previously discussed the outer body and the inner body can be designed so that the temperature difference ΔT between the facing surfaces of the inlet nozzle assembly and the product is less than 5 degrees Celsius during operation. For example, based on the low thermal conductivity and the thickness of the walls the design of the flow can be determined so that the ΔT towards the product does not exceed a determined temperature, e.g. 5 degrees Celcius.

Although some embodiments have been described and shown in detail, the disclosure is not restricted to such details, but may also be embodied in other ways within the scope of the subject matter defined in the following claims. In particular, it is to be understood that other embodiments may be utilized, and structural and functional modifications may be made without departing from the scope of the present invention.

Benefits, other advantages, and solutions to problems have been described herein with regard to specific embodiments. However, the benefits, advantages, solutions to problems, and any component(s)/unit(s) that may cause any benefit, advantage, or solution to occur or become more pronounced are not to be construed as critical, required, or essential features or components/elements of any or all the claims or the invention. The scope of the invention is accordingly to be limited by nothing other than the appended claims, in which reference to an component/unit/element in the singular is not intended to mean □one and only one□ unless explicitly so stated, but rather □one or more.□ A claim may refer to any of the preceding claims, and □any□ is understood to mean □any one or more□ of the preceding claims.

As used, the singular forms a, an, and the are intended to include the plural forms as well (i.e. to have the meaning at least one), unless expressly stated otherwise.

It should be appreciated that reference throughout this specification to “one embodiment” or “an embodiment” or □an aspect□ or features included as may means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein, but is to be accorded the full scope consistent with the language of the claims, wherein reference to an element in the singular is not intended to mean □one and only one□ unless specifically so stated, but rather □one or more.□ Unless specifically stated otherwise, the term □some□ refers to one or more.

### REFERENCE NUMBERS

1, 501 infusion heater
2, 502 infusion tank
3, 503 infusion chamber
4, 400a, 400b, 504, 604 inlet nozzle
5, 505 the inlet area
6 product outlet
7 outlet area
8□, 8□□; 508□, 508□□ steam inlets
9 walls of the infusion tank
10, 610 a cup-shaped outer body
11 base plate
12, 401a, 401b, annular wall
13 open end
14, 614 cavity
15, 402a, 402b, 615 inner body
16, 616 surfaces of the inner body facing the outer body
17, 617 surfaces of the outer body facing the inner body
18, 618 cavity channel
19, 519, 619 inlet channel
20, 520 air vent
21 steam distribution plate
22□, 22□□ multiple thoroughgoing holes
23 central through going hole
25, 403a, 403b□, 625 outlet opening
26 outer edge lip
27 inner edge lip
28, 528 concentric cooler
404b□ interruption members
600 inlet nozzle assembly
630 inlet pipe
631 collar element
632 distribution element
633 transverse distribution surface
634 an annular flange element
635 outer threads
636 central stub
637 inner threads
638 hex-nut head
639 arm
640 central section
641 outer section
642□, 642□□, 642□□□ and 642□□□ annularly arranged openings
643□, 643□□, 643□□□ and 643□□□□ interruption members
644 attachment construction
645 annular flange
646 through going holes
650 inner threads on the annular flange element
651 outer threads on the collar element
652 inner recess
653□, 653□□, 653□□□ and 653□□□ O-rings
L longitudinal axis
S steam inlet axis
C cone surface, shown as broken line
A apex
dA, distance of Apex A from product outlet
dO, extent of outer edge lip along longitudinal axis
P product

### EMBODIMENTS

1. An infusion heater (1) for heating a liquid product, comprising an infusion tank (2) defining an infusion chamber (3) comprising an inlet nozzle (4) arranged in an inlet area (5) and a product outlet (6) arranged in an outlet area (7), the inlet area (5) and the outlet area (7) are arranged opposite each other so that in operation the liquid product enters the infusion chamber (3) through the inlet nozzle (4) travels vertically through the infusion chamber (3) in free fall along a longitudinal axis L-L of the infusion chamber (3) and exits the infusion chamber (3) through the product outlet (6), wherein the infusion chamber (3) further comprises at least one steam inlet (8) arranged so that in operation steam enters the chamber between the product and the infusion chamber walls (9), wherein the inlet nozzle (4) comprises a cup-shaped outer body (10), comprising a base plate (11) and an annular wall (12) extending from the base plate (11) to an open end (13) defining a cavity (14) facing the outlet area (7), and wherein an inner body (15) is at least partly received in the cavity and that the inner body is dimensioned so that surfaces (16) of the inner body facing the surfaces (17) of the outer body are offset so that a cavity channel (18) is defined between the inner body (15) and the outer body (10), wherein at least one inlet channel (19) extend through the base plate (11) in communication with the cavity channel (18) so that in operation product is injected into the inlet nozzle (4) through the inlet channel (19) and further through the cavity channel (18) and out into the infusion chamber via an at least one outlet opening (25) at the end of the cavity channel (18) downstream from the inlet channel (19).
2. Infusion heater according to embodiment 1, wherein the inner surface (22) of the annular wall (12) tapers inwardly toward the open end (13).
3. Infusion heater according to embodiment 2, wherein the inner surface (22) describes a cone surface around the longitudinal axis L□ L with where the apex is arranged between the product outlet and up to 20% of the extent of the infusion chamber along longitudinal axis L-L, into the infusion chamber from the product outlet.
4. Infusion heater according to embodiment 1, 2 or 3, wherein the outer body and the inner body are designed so that the temperature difference between the facing surfaces of the inlet nozzle and the product is less than 5 degrees Celsius during operation.
5. Infusion heater according to embodiment 1, 2, 3 or 4, wherein an outer edge lip of the annular wall of the outer body extends beyond an opposing inner edge lip of the inner body along the longitudinal axis L□ L toward the outlet area.
6. Infusion heater according to embodiment 5, wherein the outer edge lip extends 0.5□ 5 mm, preferably 1□ 3 mm beyond the inner edge lip of the inner body.
7. Infusion heater according to any one of the preceding embodiments, wherein the offset decreases from the inlet channel (19) towards the outlet opening (25).
8. Infusion heater according to any one of the preceding embodiments, wherein coupling arrangements provided on the outer and inner body to couple them together
9. Infusion heater according to embodiment 8, wherein the coupling arrangement comprises a bolt extending through a bolt channel in the inner body along longitudinal axis L□ L and engages with a threaded mating part suspended in the inlet channel by multiple attachment bridges allowing the product to flow between the attachment bridges during operation.
10. Infusion heater according to embodiment 9, wherein multiple spacers are formed as protrusions on the surface of the inner body facing the base plate.
11. Infusions heater according to any one of the preceding embodiments, wherein a steam distribution plate (21) is arranged in the inlet area (5) between the at least one steam inlet (8) and the inlet nozzle (4) relative to the longitudinal axis L-L, wherein multiple thoroughgoing holes (22) are arranged in the steam distribution plate.
12. Infusions heater according to embodiment 11, wherein the thoroughgoing holes (22) are arranged in a ring-shaped pattern encircling the longitudinal axis L□ L.
13. Infusion heater according to any one of the preceding embodiments, wherein an air vent (20) is arranged in the lower half of the chamber.
14. Infusion heater according to any one of the preceding embodiments, wherein an at least one interruption member is arranged in the cavity channel so that in operation the at least one interruption member interrupts the flow of the product in the cavity channel.
15. Infusion heater according to embodiment 14, wherein the at least one interruption member comprises a protrusion extending from the surface of the inner body facing the outer body.
16. Infusion heater according to embodiment 14 or 15, wherein the at least one interruption member is arranged at the at least one outlet opening.
17. Infusion heater according to any one of the preceding embodiments, wherein the at least one outlet opening is annular.
18. Infusion heater according to any one of the preceding embodiment, wherein the at least one steam inlet extends along an steam axis S□ S, and where the steam axis S□ S forms and oblique angle α to the longitudinal axis L□ L.
19. Infusion heater according to embodiment 18, wherein the angle α is in the range of 20□□ 70□, preferably 45□.
20. Infusion heater according to any one of the preceding embodiments, wherein the passage from the at least one steam inlet toward the longitudinal axis is unobstructed.
21. Infusion heater according to any one of the preceding embodiments, wherein the at least one steam inlet is arranged between the inlet nozzle and the product outlet along the longitudinal axis L□ L.
22. An inlet nozzle for use in an infusion heater, wherein the inlet nozzle (4) comprises a cup-shaped outer body (10), comprising a base plate (11) and an annular wall (12) extending from the base plate (11) to an open end (13) defining a cavity (14), and wherein an inner body (15) is at least partly received in the cavity (14) and that the inner body is dimensioned so that surfaces (16) of the inner body facing the surfaces (17) of the outer body are offset so that a cavity channel (18) is defined between the inner body (15) and the outer body (10), wherein at least one inlet channel (19) extend through the base plate (11) in communication with the cavity channel (18) so that in operation product is injected into the inlet nozzle (4) through the inlet channel (19) and further through the cavity channel (18) and out into the infusion chamber via an at least one outlet opening (25) at the end of the cavity channel (18) downstream from the inlet channel (19).
23. Inlet nozzle according to embodiment 22, wherein the inner surface (22) of the annular wall (12) tapers inwardly toward the open end (13).
24. Inlet nozzle according to embodiment 22 or 23, wherein the outer body and the inner body are designed so that the temperature difference between the facing surfaces of the inlet nozzle and the product is less than 5 degrees Celsius during operation.
25. Inlet nozzle according to embodiment 22, 23 or 24, wherein an outer edge lip of the annular wall of the outer body extends beyond an opposing inner edge lip of the inner body.
26. Inlet nozzle according to embodiment 25, wherein the outer edge lip extends 0.5□ 5 mm, preferably 1□ 3 mm beyond the opposing inner edge lip of the inner body.
27. Inlet nozzle according to any one of the embodiments 22□ 26, wherein the offset decreases from the inlet channel (19) towards the outlet opening (25).
28. Inlet nozzle according to any one of the embodiments 22-27, wherein coupling arrangements provided on the outer and inner body to couple them together
29. Inlet nozzle according to embodiment 28, wherein the coupling arrangement comprises a bolt extending through a bolt channel in the inner body along longitudinal axis L□□ L□ and engages with a threaded mating part suspended in the inlet channel by multiple attachment bridges allowing the product to flow between the attachment bridges during operation.
30. Inlet nozzle according to any one of the embodiment 22-29, wherein multiple spacers are formed as protrusions on the surface of the inner body facing the base plate.
31. Inlet nozzle according to any one of the embodiments 22-30, wherein an at least one interruption member is arranged in the cavity channel so that in operation the at least one interruption member interrupts the flow of the product in the cavity channel.
32. Inlet nozzle according to embodiment 31, wherein the at least one interruption member comprises a protrusion extending from the surface of the inner body facing the outer body.
33. Inlet nozzle according to embodiment 31 or 32, wherein the at least one interruption member is arranged at the at least one outlet opening.
34. Inlet nozzle according to any one of the embodiments 22□ 33, wherein the at least one outlet opening is annular.
35. Inlet nozzle according to any one of the embodiments 22□ 34, comprising a single inlet channel.
36. Inlet nozzle according to embodiment 35, wherein the single inlet channel extends through the centre of the base plate along a longitudinal axis L□□ L□.
37. Inlet nozzle according to embodiment 35 or 36, wherein the single inlet channel extends into a first part of the cavity channel extending transverse to the longitudinal L□□ L□.
38. Inlet nozzle according to embodiment 37, wherein the first part of the cavity channel extends into a second part of the cavity channel extending along the longitudinal axis L□ □ L□ towards the outlet opening.
39. An infusion heater for heating a liquid product, wherein the infusion heater comprises an infusion tank defining an infusion chamber comprising an inlet nozzle arranged in an inlet area and a product outlet arranged in an outlet area, the inlet area and the outlet area are arranged opposite each other so that in operation the liquid product enters the infusion chamber through the inlet nozzle travels vertically through the infusion chamber in free fall along a longitudinal axis L-L of the infusion chamber and exits the infusion chamber through the product outlet, wherein the infusion chamber further comprises at least one steam inlet arranged so that in operation steam enters the chamber between the product and the infusion chamber walls, wherein the infusion heater further comprises an air vent which is arranged in the lower half of the infusion chamber
40. An infusion heater for heating a liquid product, wherein the infusion heater comprises an infusion tank defining an infusion chamber comprising an inlet nozzle arranged in an inlet area and a product outlet arranged in an outlet area, the inlet area and the outlet area are arranged opposite each other so that in operation the liquid product enters the infusion chamber through the inlet nozzle travels vertically through the infusion chamber in free fall along a longitudinal axis L-L of the infusion chamber and exits the infusion chamber through the product outlet, wherein the infusion chamber further comprises at least one steam inlet arranged so that in operation steam enters the chamber between the product and the infusion chamber walls, wherein the infusion heater further comprises a steam distribution plate comprising an annular disc configured to be arranged in an infusion chamber.
41. An infusion heater according to embodiment 40, where the steam distribution plate further comprises multiple through going holes arranged in a ring-shaped pattern encircling the centre of the annular disc.
42. An infusion heater for heating a liquid product, wherein the infusion heater comprises an infusion tank defining an infusion chamber comprising an inlet nozzle arranged in an inlet area and a product outlet arranged in an outlet area, the inlet area and the outlet area are arranged opposite each other so that in operation the liquid product enters the infusion chamber through the inlet nozzle travels vertically through the infusion chamber in free fall along a longitudinal axis L-L of the infusion chamber and exits the infusion chamber through the product outlet, wherein the infusion chamber further comprises at least one steam inlet arranged so that in operation steam enters the chamber between the product and the infusion chamber walls, wherein the at least one steam inlet extends along an steam axis S□ S which form an oblique angle α to the longitudinal axis L□ L.
43. Infusion heater according to embodiment 42, wherein the angle α is in the range of 20□□ 70□, preferably 45□.
44. Infusion heater according to embodiment 42 or 43, wherein the passage from the at least one steam inlet toward the longitudinal axis is unobstructed.
45. Infusion heater according to embodiment 42, 43 or 44, wherein the steam inlet is arranged between the inlet nozzle and the product outlet.

1-31. (canceled)

32. An infusion heater for heating a liquid product, comprising an infusion tank defining an infusion chamber comprising an inlet nozzle arranged in an inlet area and a product outlet arranged in an outlet area, the inlet area and the outlet area are arranged opposite each other so that in operation the liquid product enters the infusion chamber through the inlet nozzle, travels vertically through the infusion chamber in free fall along a longitudinal axis L-L of the infusion chamber and exits the infusion chamber through the product outlet, wherein the infusion chamber further comprises at least one steam inlet arranged so that in operation steam enters the chamber between the liquid product and the infusion chamber walls,
wherein the inlet nozzle comprises a cup-shaped outer body, comprising a base plate and an annular wall extending from the base plate to an open end defining a cavity facing the outlet area, and wherein an inner body is at least partly received in the cavity and that the inner body is dimensioned so that surfaces of the inner body facing the surfaces of the outer body are offset so that a cavity channel is defined between the inner body and the outer body, wherein at least one inlet channel extends through the base plate in communication with the cavity channel, so that in operation the liquid product is injected into the inlet nozzle through the inlet channel and further through the cavity channel and out into the infusion chamber via at least one outlet opening at an end of the cavity channel downstream from the inlet channel.

33. Infusion heater according to claim 32, wherein an inner surface of the annular wall tapers inwardly towards the open end.

34. Infusion heater according to claim 33, wherein the inner surface describes a cone surface around the longitudinal axis L□ L, where an apex of the cone is arranged between the product outlet and up to 0-20% of an extent of the infusion chamber along longitudinal axis L-L, into the infusion chamber from the product outlet.

35. Infusion heater according to claim 32, wherein the outer body and the inner body are designed so that the temperature difference between the facing surfaces of the inlet nozzle and the liquid product is less than 5 degrees Celsius during operation.

36. Infusion heater according to claim 32, wherein an outer edge lip of the annular wall of the outer body extends beyond an opposing inner edge lip of the surface of the inner body along the longitudinal axis L□ L towards the outlet area.

37. Infusion heater according to claim 32, wherein the offset decreases from the inlet channel towards the outlet opening.

38. Infusion heater according to claim 32, wherein a steam distribution plate is arranged in the inlet area between the at least one steam inlet and the inlet nozzle relative to the longitudinal axis L-L, wherein multiple thoroughgoing holes are arranged in the steam distribution plate.

39. Infusions heater according to claim 38, wherein the thoroughgoing holes are arranged in a ring-shaped pattern encircling the longitudinal axis L□ L.

40. Infusion heater according to claim 32, wherein at least one interruption member is arranged in the cavity channel so that in operation the at least one interruption member interrupts the flow of the product in the cavity channel.

41. Infusion heater according to claim 40, wherein the at least one interruption member comprises a protrusion extending from the surface of the inner body facing the outer body.

42. Infusion heater according to claim 40, wherein the at least one interruption member is arranged at the at least one outlet opening.

43. Infusion heater according to claim 32, wherein the at least one steam inlet extends along an steam axis S□ S, and where the steam axis S□ S forms and oblique angle α to the longitudinal axis L□ L, wherein the angle α is in the range of 20□□ 70□, or 45□.

44. An inlet nozzle for use in an infusion heater, wherein the inlet nozzle comprises a cup-shaped outer body, comprising a base plate and an annular wall extending from the base plate to an open end defining a cavity, and wherein an inner body is at least partly received in the cavity and that the inner body is dimensioned so that surfaces of the inner body facing the surfaces of the outer body are offset so that a cavity channel is defined between the inner body and the outer body, wherein at least one inlet channel extend through the base plate in communication with the cavity channel so that in operation liquid product is injected into the inlet nozzle through the inlet channel and further through the cavity channel and out into the infusion chamber via at least one outlet opening at an end of the cavity channel downstream from the inlet channel.

45. Inlet nozzle according to claim 40, wherein an inner surface of the annular wall tapers inwardly toward the open end.

46. Inlet nozzle according to claim 40, wherein the outer body and the inner body are designed so that the temperature difference between the facing surfaces of the inlet nozzle and the liquid product is less than 5 degrees Celsius during operation.

47. Inlet nozzle according to claim 40, wherein an outer edge lip of the annular wall of the outer body extends beyond an opposing inner edge lip of the inner body

48. Inlet nozzle according to claim 47, wherein the outer edge lip extends 0.5□5 mm, or 1□ 3 mm, beyond the inner edge lip.

49. Inlet nozzle according to claim 40, wherein the offset decreases from the inlet channel towards the outlet opening.

50. Inlet nozzle according to claim 40, wherein at least one interruption member is arranged in the cavity channel so that in operation the at least one interruption member interrupts the flow of the liquid product in the cavity channel.

51. Inlet nozzle according to claim 50, wherein the at least one interruption member comprises a protrusion extending from the surface of the inner body facing the outer body.

52. Inlet nozzle according to claim 50, wherein the at least one interruption member is arranged at the at least one outlet opening.

53. Inlet nozzle according to claim 40, comprising a single inlet channel extending through the centre of the base plate along a longitudinal axis L□□ L□.

54. Inlet nozzle according to claim 40, comprising a single inlet channel extending into a first part of the cavity channel extending transverse to the longitudinal L□□ L□.
